(19) United States
(12) Patent Application Publication
(10) Pub. No.: US 2007/0123234 A1
(43) Pub. Date: May 31, 2007

(54) Caller ID mobile terminal

(75) Inventor: Min-Su Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/540,731

(22) Filed: Oct. 2, 2006

(30) Foreign Application Priority Data
Sep. 30, 2005 (KR) 92610/2005

(51) Int. Cl. H04Q 7/38; H04Q 7/22; H04M 3/42

(52) U.S. Cl. 455/414.1

(57) ABSTRACT

Disclosed is a caller ID mobile terminal which allows a user to exactly identify a caller. The user can exactly recognize the caller as voices directly recorded and stored by the user by individual or voices reading nicknames entered in text ring as bell tones, and further the user can be amused by using various versions of voices as bell tones through emoticons or the like.

### BACKGROUND OF THE INVENTION

1. Field of the Invention

The present invention relates to a mobile phone, and more particularly to, a caller ID mobile terminal which allows a mobile terminal user to identify a caller.

2. Description of the Prior Art

With the increase of users' demands for the performance of mobile phones, mobile phones are being rapidly developed through the convergence of various functions, including MP3, high-pixel cameras, etc. However, the interest has been focused only on higher-pixel cameras, higher-volume memories, and other new functions, so the convenience of mobile terminal users has not actually increased much.

In general, in the prior art, in order for a mobile terminal user to identify the caller before answering the call, the caller's telephone number or the caller's name was displayed on a display of the mobile terminal.

Further, to relieve the user inconvenience of having to view the display of the mobile terminal in order to identify the caller, different bell tones are assigned by group or individual when storing telephone numbers in a telephone directory of the mobile terminal or modifying contents stored in the telephone directory. Thus, when someone calls, the user can know who is calling depending on the bell tone assigned by the user since the bell tone assigned by the user rings by caller identification.

For example, as in FIG. 1, in a case where the user enters the person A's telephone number and other information, and stores them in a telephone directory after assigning them in a manner that No. 1 bell tone rings when someone calls from this telephone number, if someone calls from the telephone number afterwards, the assigned No. 1 bell tone rings. The user can recognize that the calling person is A upon hearing No. 1 bell tone.

However, in the prior art for identifying a caller depending on bell tones by individual and group, there was a problem that the user must remember all of tens of bell tones assigned in the telephone directory and all the persons corresponding to the bell tones.

Moreover, due to the limitation on the number of bell tones that can be stored in the mobile terminal, it was not possible to assign different bell tones for all the persons stored in the telephone directory, thus other people, except for a few certain acquaintances, had to be grouped into friends, relatives, coworkers, and so on for assigning bell tones, which brought about a problem that the user cannot be informed of who exactly the caller is.

### BRIEF DESCRIPTION OF THE INVENTION

The present invention has been made in an effort to overcome the above problems, and provide a caller ID mobile terminal, which allows a mobile terminal user to recognize who exactly the caller is.

To achieve these and other advantages and in accordance with the purpose of the present invention, as embodied and broadly described herein, there is provided a caller ID mobile terminal, comprising: a transmitting/receiving unit for transmitting/receiving signals; a memory unit for storing information of music type bell tones and announcement type bell tones which are set by user; a control unit for outputting a music type bell tone after outputting a speech type bell tone with reference to the information on the bell tones when the speech type bell tone is set; a speaker unit for outputting bell tones by means of the control unit; and a display unit for displaying information.

Preferably, the memory unit stores voices for all syllables and various versions of voices.

Preferably, the memory unit comprises a telephone directory database including a field containing user-entered nickname information; and a field containing information on a bell tone assigned to a corresponding telephone number.

The field containing information on a bell tone contains information for identifying whether a user-assigned bell tone is an announcement type bell tone or a music type bell tone, information for identifying what sound source is assigned, and information for identifying whether the announcement type bell tone is recorded directly by the user or in conjunction with the field containing nickname information.

Preferably, the control unit identifies whether a user-assigned bell tone is a music type bell tone, or an announcement type bell tone recorded directly by the user, or an announcement type bell tone in conjunction with the nickname field according to the type of the bell tone with reference to the field containing information on a bell tone. If the user-assigned bell tone is a music type bell tone, the control unit outputs a corresponding sound source. Alternately, if the user-assigned bell tone is an announcement type bell tone recorded directly by the user, the control unit outputs a music type bell tone after outputting a recorded voice. Alternately, if the user-assigned bell tone is an announcement type bell tone in conjunction with the field containing nickname information, the control unit analyzes the syllables of a nickname stored in the field containing nickname information, thereby outputting a music type bell tone after outputting a corresponding voice as machine sound.

Preferably, the mobile terminal further comprises: a display unit which, when someone calls, displays the caller's name stored in the telephone directory database of the memory unit, a nickname, or a user-assigned icon or picture according to the control of the control unit.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a telephone number storage screen in accordance with the prior art;

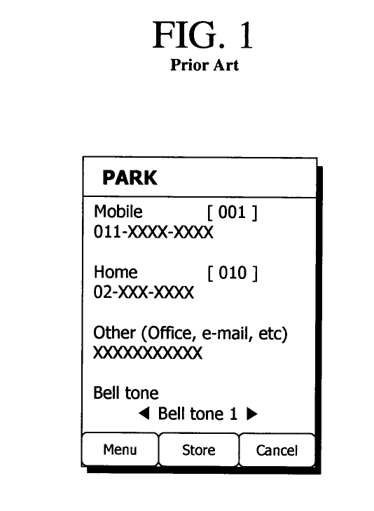

FIG. 2 is a block diagram showing the configuration of a caller ID mobile terminal in accordance with an embodiment of the present invention;

FIG. 3 is a block diagram showing the structure of a telephone directory database in accordance with an embodiment of the present invention;

FIG. 4 is a view showing a user's telephone directory storage screen in accordance with an embodiment of the present invention; and

FIG. 5 is a sequential view showing the procedure of storing a telephone number and identifying a caller using a caller ID mobile terminal in accordance with an embodiment of the present invention.

### DETAILED DESCRIPTION OF THE INVENTION

Preferred embodiments of the present invention will now be described with reference to the accompanying drawings.

In the following description, unnecessary detail of known functions and constructions may be omitted from the description so as not to obscure the present invention.

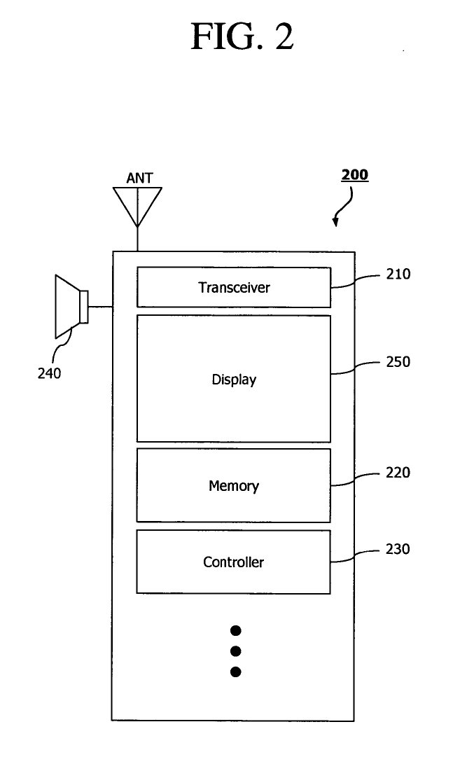

FIG. 2 is a block diagram showing the configuration of a caller ID mobile terminal in accordance with an embodiment of the present invention.

As shown in FIG. 2, the caller ID mobile terminal 200 comprises: a transmitting/receiving unit 210 for transmitting/receiving signals; a memory unit 220 for storing information of music type bell tones (hereinafter, “music bell”) and announcement type bell tones (hereinafter, “announcement bells”) which are set by user; a control unit 230 for outputting a music type bell tone after outputting a speech type bell tone with reference to the information on the bell tones when the speech type bell tone is set; and a speaker unit 240 for outputting bell tones by means of the control unit 230.

The mobile terminal 200 further comprises: a display unit 250 which, when someone calls, displays the caller's name stored in the telephone directory database of the memory unit 220, a nickname, or a user-assigned icon or picture according to the control of the control unit 230.

The memory unit 220 is able to store machine sounds for all syllables, such as “Ah, Yah, Uh, Yuh, Go, Gyo, GU, Gyu, . . . ”. Also, the memory unit 220 can store the voices in different versions, including a cute baby voice, a cheesy male voice, a gentle female voice, etc. The machine sounds are used when the other party's name or nickname entered in text by the user are output as announcement bells. The other party's name or nickname may be stored in the memory unit 220 or received from the other party, and outputted as machine sounds by Text-to-speech (TTS) function.

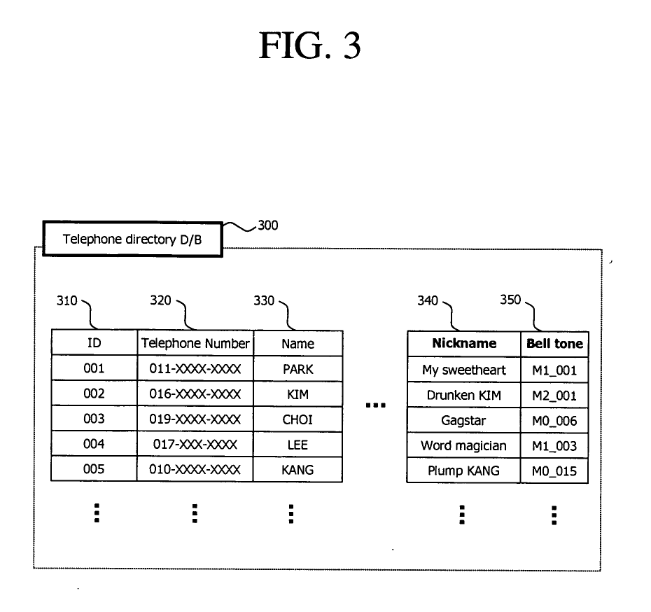

The memory unit 220 stores in a database various data of the telephone directory containing various information based on telephone numbers, which will be described with reference to FIG. 3.

FIG. 3 is a block diagram showing the structure of a telephone directory database in accordance with an embodiment of the present invention.

Referring to FIG. 3, the telephone directory database 300 comprises general reference fields, including: an identifier field 310 for storing information of an identifier (generally, an address storing a telephone number), which is a value for identifying each telephone number; a telephone number field 320 for storing information of a telephone number; and a name field 330 for containing information of a name (mostly, calling party's name) assigned when the user stores a corresponding telephone number. Besides, the telephone directory database 300 further comprises: a field (hereinafter, nickname field) 340 containing nickname information entered in text by the user; and a field (hereinafter, bell tone field) 350 containing information on a bell tone assigned to a corresponding telephone number.

The bell tone field 350 contains information for identifying whether a user-assigned bell tone is an announcement bell or a music bell, and information for identifying what sound source (what number sound source) is assigned. Also, the bell tone field 250 contains information for identifying whether the announcement bell is recorded directly by the user (hereinafter, a recorded announcement bell) or in conjunction with the field containing nickname information (hereinafter, a text announcement bell). Moreover, in case of the text announcement bell, information (hereinafter, version information) for identifying a cute baby voice, a cheesy male voice, a gentle female voice, etc. can be optionally contained.

For instance, if it is assumed that MO represents a music bell, Ml represents recorded an announcement bell, and M2 represents a text announcement bell, M0_001 indicates that a bell tone is assigned as a first file of music bell, and M1_003 indicates that a bell tone is assigned as a third file of recorded announcement bell. And, M2_001 indicates that a bell tone is a text announcement bell assigned as a nickname stored in the corresponding nickname field 340, and is assigned as a first version (e.g., the cute baby voice version). Meanwhile, it is also possible to ring at least two bell tones at the same time. For instance, if a bell tone is assigned as M0_001*M2_001, a first file of music bell and a voice of a first version of text announcement bell are output at the same time.

The control unit 230 identifies whether a user-assigned bell tone is a music bell, or an announcement bell recorded directly by the user, or an announcement bell in conjunction with the nickname field entered in text by the user. If the user-assigned bell tone is a music bell, the control unit 230 outputs a corresponding sound source. If the user-assigned bell tone is an announcement bell recorded directly by the user, the control unit 230 outputs a recorded voice. If the user-assigned bell tone is an announcement bell liked with the nickname filed entered in text by the user, the control unit 230 analyzes the syllables of the nickname stored in the nickname field 340, thereby outputting a corresponding voice as machine sound. To prevent repetitive outputting the recorded voice or the machine sound, the control unit 230 outputs a music bell after outputting the recorded voice or the machine sound.

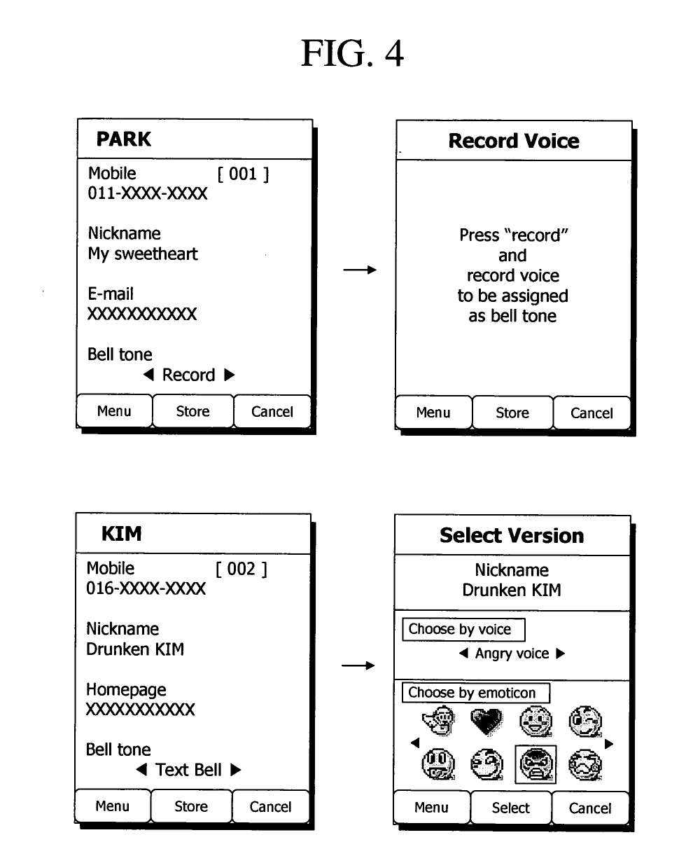

FIG. 4 is a view showing a user's telephone directory storage screen in accordance with an embodiment of the present invention.

As shown in FIG. 4, when the user stores a telephone number in the mobile terminal, he or she assigns a bell tone after entering the calling party's telephone number, name, nickname, etc. The bell tone ringing when someone calls is varied depending on what bell tone is assigned. At this time, if the user assigns a recorded announcement bell as the bell tone, a message or screen instructing the user to record is displayed as shown in the drawing. Next, if the user records according to an instruction, a recorded voice is assigned as the bell tone of the corresponding number. Then, when someone calls afterwards, the voice recorded by the user is output.

In a case where a text announcement bell is assigned as the bell tone, a voice version can be optionally assigned. Various versions of voices can be selected, including, for example, if the user chooses “baby voice”, a cute baby voice is output as machine sound, and if the user chooses “female voice”, a gentle female voice is output. Then, the nickname entered in text is output as machine sound depending on the corresponding version.

Additionally, it is possible to select version information in conjunction between a bell tone and an emoticon. The text announcement bell can ring in various manners and versions, including, for example, if an angry face emoticon is chosen, the nickname stored as an angry voice is read, and if an angel emoticon is chosen, the nickname stored as a baby voice is read.

It is also possible to output at least two of a machine sound bell tone, a user voice bell tone and a music bell by using the above method. For instance, if the bell tone is assigned by selecting a menu like “music bell+text announcement bell”, which assigns both music bell and text announcement bell at the same time, when the calling party calls afterwards, both of a music type bell tone and a machine sound reading the nickname entered in text by the user in the corresponding version are output at the same time.

Besides, both of music bell and recorded announcement bell may be output at the same time, both of recorded announcement bell and text announcement bell may be output at the same time, or all of music bell, recorded announcement bell, and text announcement bell can be output at the same time.

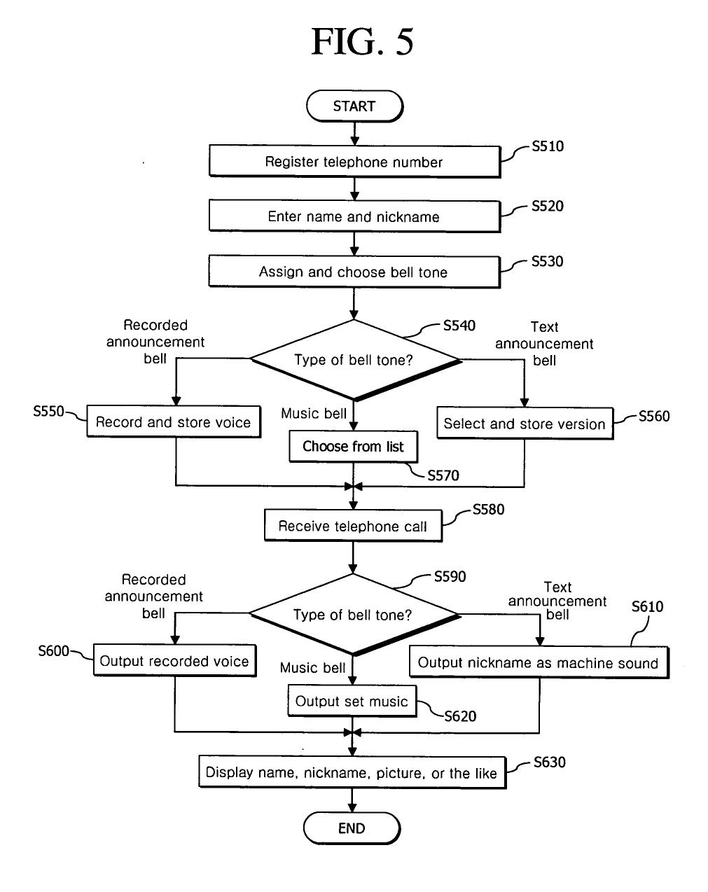

FIG. 5 is a sequential view showing the procedure of storing a telephone number and identifying a caller using a caller ID mobile terminal in accordance with an embodiment of the present invention.

As shown in FIG. 5, if the user wants to enter and register a person's telephone number (S510), he or she enters a nickname representing a feature of the person (S520). Once the entry of all desired choices is complete, when the person calls, at least one of music bell, voice announcement bell, and text announcement bell is selected and assigned as the bell tone to ring (S530).

At this time, if the voice announcement bell is selected, a voice is recorded and stored (S550), and if the text announcement bell is selected, a voice version is selected and stored (S560). If the music bell is selected, a bell tone is selected from the list (S570). If two or more of them are selected, all the corresponding procedures are executed. For instance, if the text announcement bell and the music bell are selected, a bell tone is selected, and a voice version is selected and stored. Of course, as mentioned above, the voice version can be selected from a text list, as well as from an emoticon list.

Afterwards, if the other party calls (S580), the type of the assigned bell tone is determined (S590). If the assigned bell tone is a voice announcement bell, a user-recorded voice is output (S600), and if the assigned bell tone is a text announcement bell, a machine sound of a nickname-assigned version is output (S610). If the assigned bell tone is a music bell, a preset music is output (S620). If the assigned bell tone is two or more, all of the corresponding bells are output, for example, if both the voice announcement bell and the music bell are assigned, a user-recorded voice and a preset music are output together.

At the same time, the name, nickname or picture stored by the user is displayed on the display unit (S630). By this, the user can recognize who is calling exactly and with fun. As mentioned above, a music bell may be outputted after outputting the recorded voice or the machine sound to prevent repetitive outputting the recorded voice or the machine sound.

As described above, the caller ID mobile terminal of the present invention has the convenient effect of allowing the user to exactly recognize the caller as voices directly recorded and stored by the user by individual or voices reading nicknames entered in text ring as bell tones.

Furthermore, the caller ID mobile terminal of the present invention has the effect of amusing the user by using sounds (machine sounds) having various versions of voices as bell tones through emoticons or the like.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile terminal, comprising:
a transmitting/receiving unit for transmitting/receiving signals;
a memory unit for storing information of music type bell tones and announcement type bell tones which are set by user;
a control unit for outputting a music type bell tone after outputting a speech type bell tone with reference to the information on the bell tones when the speech type bell tone is set;
a speaker unit for outputting bell tones by means of the control unit; and
a display unit for displaying information.

2. The mobile terminal of claim 1, wherein the announcement type bell tone is a voice data which is recorded directly by the user or a data which contains information for outputting nickname which is inputted by user as voice.

3. The mobile terminal of claim 3, wherein the data which contains information for outputting nickname is outputted as a machine sound which has various versions of voices.

4. The mobile terminal of claim 3, wherein the versions of voices are output on the display unit as a text list and selected by the user.

5. The mobile terminal of claim 3, wherein the versions of voices are output on the display unit as an emoticon list and selected by the user.

6. The mobile terminal of claim 1, wherein the memory unit comprises a telephone directory database including a field containing nickname information; and a field containing information on a bell tone assigned to a corresponding telephone number.

7. The mobile terminal of claim 1, wherein the field containing information on a bell tone contains information for identifying whether a user-assigned bell tone is an announcement type bell tone or a music type bell tone or both, and information for identifying what sound source is assigned.

8. The mobile terminal of claim 1, wherein the field containing information on a bell tone contains information for identifying whether the announcement type bell tone is recorded directly by the user or in conjunction with the field containing nickname information or both.

9. The mobile terminal of claim 1, wherein the control unit identifies whether a user-assigned bell tone is a music type bell tone, or an announcement type bell tone recorded directly by the user, or an announcement type bell tone in conjunction with the nickname field, or at least two of the three types of bells, according to the type of the bell tone with reference to the bell tone field.

10. The mobile terminal of claim 9, wherein if the user-assigned bell tone is a music type bell tone, the control unit outputs a corresponding sound source.

11. The mobile terminal of claim 9, wherein if the user-assigned bell tone is an announcement type bell tone recorded directly by the user, the control unit outputs a music type bell tone after outputting a corresponding voice.

12. The mobile terminal of claim 9, wherein if the user-assigned bell tone is an announcement type bell tone in conjunction with the nickname field, the control unit analyzes the nickname information stored in the field containing nickname information, thereby outputting a music type bell tone after outputting a corresponding voice as machine sound.

13. The mobile terminal of claim 9, wherein if the user-assigned bell tone is at least two of a music type bell tone, an announcement type bell tone recorded directly by the user, and an announcement type bell tone in conjunction with the nickname field, all corresponding bells ring.

14. The mobile terminal of claim 1, wherein the information which is displayed at the display unit is caller's information including the caller's name or nickname stored in the telephone directory database of the memory unit or an icon or picture assigned by the user.

15. The mobile terminal of claim 1, wherein the announcement type bell tone is in conjunction with various emoticons which are matched various versions of voice respectively.

16. The mobile terminal of claim 1, wherein the announcement type bell tone is outputted as machine sound by a function of TTS (Text-to-speech).

17. A caller ID mobile terminal, which uses as a bell tone a nickname that is entered in text by a user by analyzing and reading the same by machine sound.

18. The caller ID mobile terminal of claim 17, wherein the machine sound has various versions of voices.

19. The caller ID mobile terminal of claim 18, wherein the various versions of voices are assigned in conjunction with emoticons.

20. A caller ID mobile terminal, which selects a version of machine sound by selecting an emoticon when using a nickname entered by a user as a bell tone by outputting the same as machine sound.
